(19) United States
(12) Patent Application Publication
(10) Pub. No.: US 2020/0027064 A1
(43) Pub. Date: Jan. 23, 2020

(54) TASK EXECUTION BASED ON ACTIVITY CLUSTERS

(71) Applicant: Microsoft Technology Licensing, LLC, Redmond, WA (US)

(72) Inventors: Abhineet Mishra, Bothell, WA (US); Sravanth Venkata Madhu Kurumaddali, Redmond, WA (US)

(73) Assignee: Microsoft Technology Licensing, LLC, Redmond, WA (US)

(21) Appl. No.: 16/041,364

(22) Filed: Jul. 20, 2018

(51) Int. Cl. G06Q 10/10; H04L 29/08; G06F 17/30

(52) U.S. Cl. CPC G06Q 10/1097; H04L 67/22; G06F 17/30598; G06F 17/3087; G06F 17/30867

(57) ABSTRACT

A system for executing tasks can include a processor to detect a plurality of user signals for a user, the plurality of user signals comprising a search history of the user. The processor can also identify activity information from the plurality of user signals, the activity information comprising an action executed by the user. The processor can generate an activity cluster based on the activity information, wherein generating the activity cluster comprises applying a clustering technique and an ordering technique to the activity information. Furthermore, the processor can execute a search query for the user based on the activity cluster comprising a plurality of activities that are clustered and ordered.

### BACKGROUND

Computing device users search for data on a growing number of devices such as desktop computers, mobile devices, digital personal assistants, and the like. In some examples, the user searches can return information related to products, topics of interest, or geographical areas of interest, among others. Accordingly, users can perform tasks based on the information returned from the user searches.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

An embodiment described herein includes a system for executing tasks can include a processor to execute code to detect a plurality of user signals for a user, the plurality of user signals comprising a search history of the user. The processor can also identify activity information from the plurality of user signals, the activity information comprising an action executed by the user. Furthermore, the processor can generate an activity cluster based on the activity information, wherein generating the activity cluster comprises applying a clustering technique and an ordering technique to the activity information. In addition, the processor can execute a search query for the user based on the activity cluster comprising a plurality of activities that are clustered and ordered.

Another embodiment described herein includes a method for executing tasks that includes detecting a plurality of user signals for a user, the plurality of user signals comprising a search history of the user. Additionally, the method can include identifying activity information from the plurality of user signals, the activity information comprising an action executed by the user. Furthermore, the method can include generating an activity cluster based on the activity information, wherein generating the activity cluster comprises applying a clustering technique and an ordering technique to the activity information. Moreover, the method can include executing a search query for the user based on the activity cluster comprising a plurality of activities that are clustered and ordered.

Yet another embodiment described herein includes one or more computer readable storage media for executing tasks that can include a plurality of instructions, that in response to execution by a processor, cause the processor to detect a plurality of user signals for a user, the plurality of user signals comprising a search history of the user. The plurality of instructions can also cause the processor to identify activity information from the plurality of user signals, the activity information comprising an action executed by the user and generate an activity cluster based on the activity information, wherein generating the activity cluster comprises applying a clustering technique and an ordering technique to the activity information. Furthermore, the plurality of instructions can also cause the processor to match an activity from a search query to a task, the task comprising the activity cluster and generate a final score indicating the activity is related to the task, the final score comprising a combination of a static score, a dynamic score, and a time difference score. Moreover, the plurality of instructions can also cause the processor to predict a subsequent activity to be executed based on the final score, wherein the subsequent activity is identified from the activity cluster, and execute the subsequent activity for the user at a predetermined time.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a block diagram illustrating an example computing device that can generate tasks and predict subsequent tasks to execute;

FIG. 2 is an example block diagram of a system for implementing a task generation engine;

FIG. 3 is a block diagram of example unclustered and unordered activities;

FIGS. 4A and 4B are block diagrams of examples of clustered and unordered activities;

FIGS. 5A and 5B are block diagrams of examples of clustered and ordered activities;

FIG. 6 is an example of a constituency tree of a search query;

FIG. 7 is another example of a constituency tree of a search query;

FIG. 8 is an example block diagram of a task prediction engine;

FIG. 9 is a process flow diagram of an example method for generating tasks;

FIG. 10 is a process flow diagram of an example method for predicting tasks;

FIG. 11 is a computing system that can generate and predict tasks; and

FIG. 12 is a block diagram of an example computer-readable storage media that can generate tasks and predict tasks.

### DETAILED DESCRIPTION

With the rise of the internet and other communication channels, an increasing amount of data is generated in the form of internet browsing history, internet search history, digital assistant's conversations, device usage, and the like. This data can provide information regarding each task which a user is performing. In the techniques described herein, tasks are identified as a temporal series of activities or time series. For example, a task can include a series of time related search queries, among others. In some embodiments, the task can include temporally related activities such as search queries corresponding to planning a trip, different queries related to purchasing a product via a web service, or different queries related to medical issues arising over time. In some examples, a search engine or a personal digital assistant can provide advertisements or suggestions based on a user's interest or preference. The user's interest can be an explicit interest provided by the user or an implicit interest inferred by a system. In techniques described herein, a device can provide suggestions for subsequent activities to execute for a user related to a task.

In some embodiments, a device can implement a framework which identifies tasks as a series of activities in chronological order using community learning from signals such as browsing history, internet search history, and the like. The device can implement a heuristic based suggestion engine that learns the task of the user and predicts the subsequent activity and the time at which the subsequent activity should be performed over the lifecycle of the task. The device can use this information to provide suggestions, such as a subsequent activity to perform, to the user at an appropriate time. In some examples, a task can be defined as a series of activities performed over a period of time in a chronological order. For example, a task can be related to a series of pregnancy questions related to a first trimester inquiry, followed by a second trimester inquiry, followed by a third trimester inquiry. In one example, a device can track information related to pregnancy inquiries based on the corresponding trimester of a user. The device can categorize these activities into a defined task, which in this case is a pregnancy life cycle. Accordingly, by having the task knowledge and knowing the activities that are generally performed over the life cycle of a task, the techniques herein can determine the suggestions to provide to users at any suitable time during a life cycle of a task. The techniques here can also continuously calculate a confidence level for recommending a subsequent activity as part of a life cycle of a task based on user input or feedback.

Thus, the present techniques enable predicting tasks to be executed. For example, the techniques herein can enable generating a task or an ordered time series of activities. As user search queries are detected, a device can access the previously identified tasks to determine or predict a subsequent activity from the previously identified tasks that a user is likely to execute at a future time. For example, the device can predict future search queries, tasks to be performed by digital assistants, and the like. The device can also provide advertising media based on an activity cluster, wherein the advertising media corresponds to predicted tasks that are likely to be executed by a user.

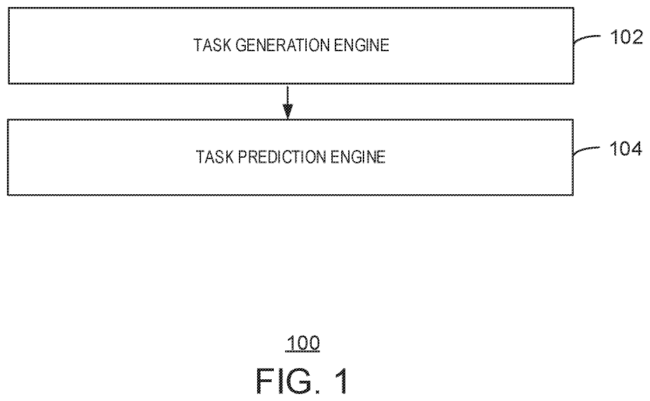

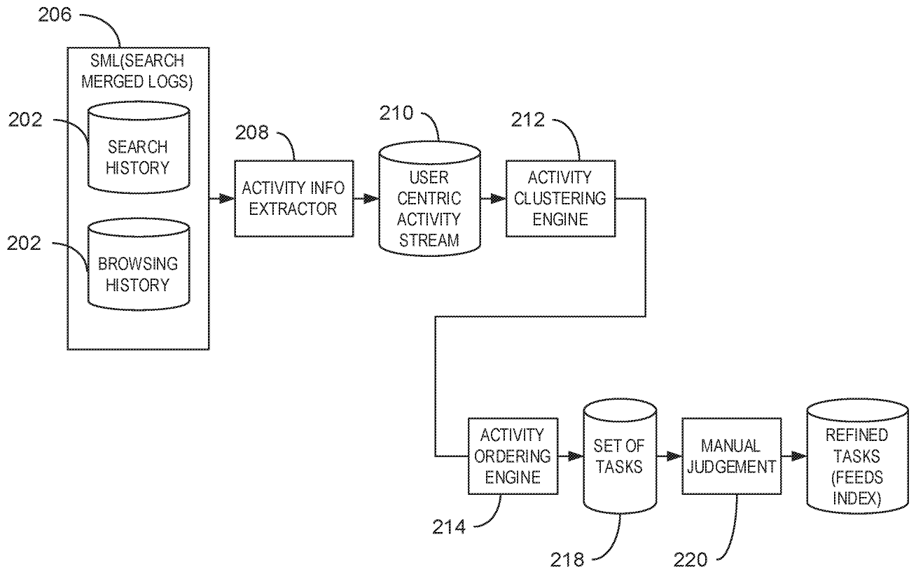

FIG. 1 is an example block diagram illustrating a computing device that can generate tasks and execute predicted tasks. In some embodiments, the computing device 100 can include a task generation engine 102 that can identify and generate tasks as a series of activities performed by users over a period of time. The task generation engine 102 can identify the tasks from community data such as browsing history, search history, digital assistant history, email history, and the like. An activity, as referred to herein, can include an action such as executing a search query, requesting an action to be performed by a digital assistant, and the like. In some examples, the task generation engine 102 can organize activities into a shared task. The task generation engine 102 can also detect a sequential order for the activities and organize the activities related to a shared task into a time series of activities related to the shared task. The techniques implemented by the task generation engine 102 to generate a time series of activities related to a shared task are described in greater detail below in relation to FIGS. 2-7, and 9.

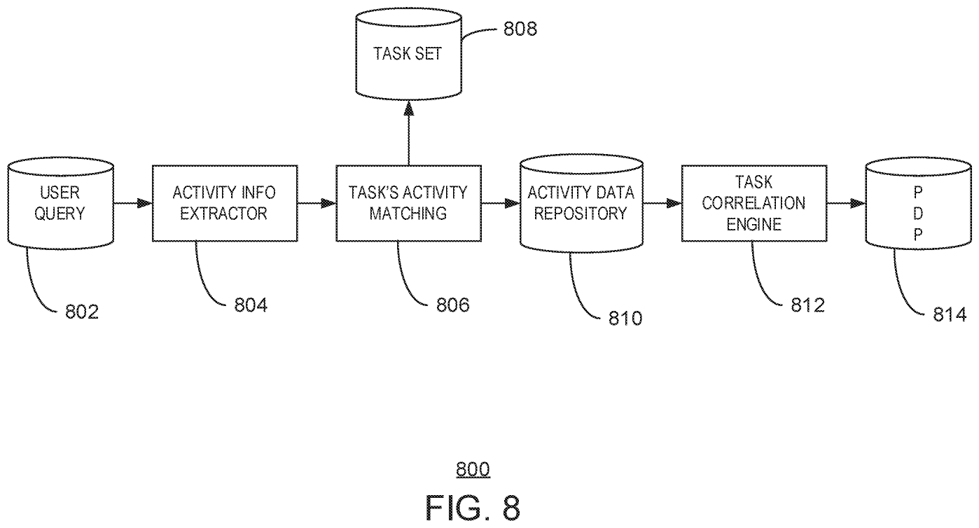

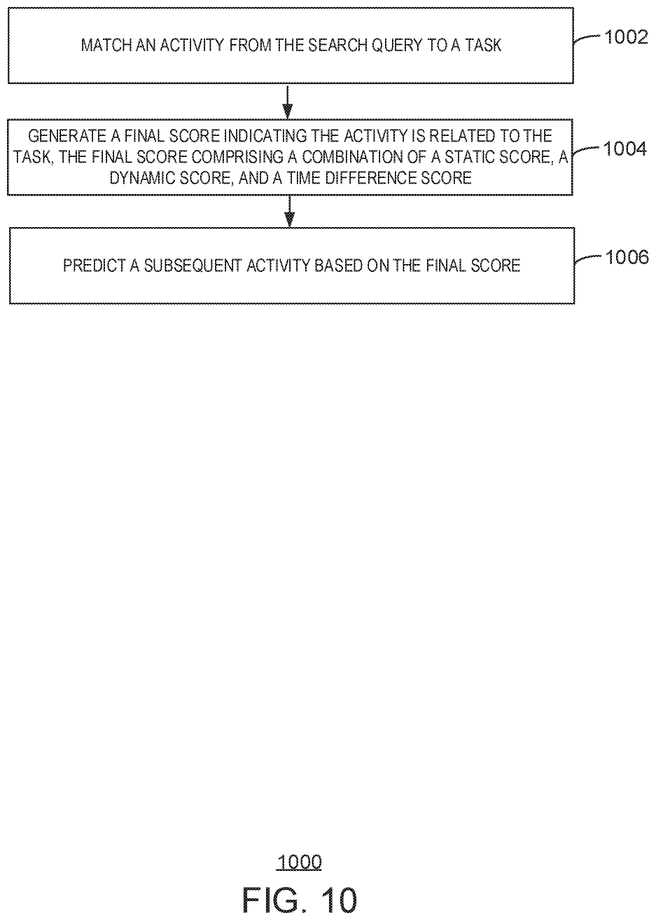

In some embodiments, a task prediction engine 104 can detect shared tasks associated with a user and predict subsequent activities related to the shared task that a user is likely to request. For example, the task prediction engine 104 can generate future tips, suggestions, reminders, and the like. As described below in relation to FIGS. 2-5, the task prediction engine 104 can determine a series of consecutive activities that represent a task. The task prediction engine 104 can also determine that a user has executed one of the activities of a task and predict a subsequent activity. The task prediction engine 104 can also determine a time gap between the activities in the time series for a task and predict a time for performing subsequent activities. In some examples, the task prediction engine 104 can use the time gap to predict a time for performing a subsequent activity such as providing future tips, suggestions, search query results, or reminders. The techniques implemented by the task prediction engine 104 are described in greater detail below in relation to FIGS. 8 and 10.

With respect to user privacy, the computing device 100 can enable a user setting to opt out of sharing a search history with a system that identifies or generates tasks. Furthermore, the device can also enable the user to opt out of receiving predicted activities related to tasks to be executed. For example, the device can enable a user setting to prevent the automatic execution of future search queries that are related to a task in which a user has expressed interest. In some embodiments, a device can enable any suitable privacy settings to prevent sharing a user's signals such as browsing history, search history, conversation history, digital assistant history, and the like.

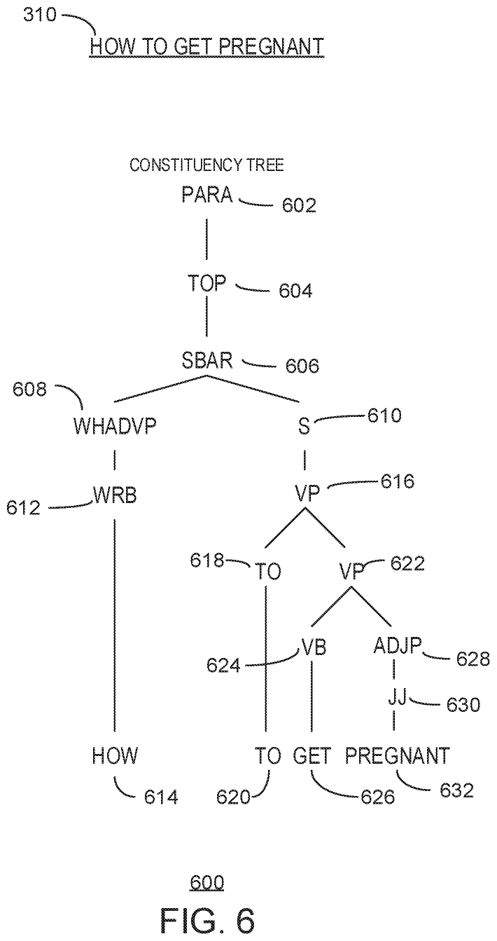

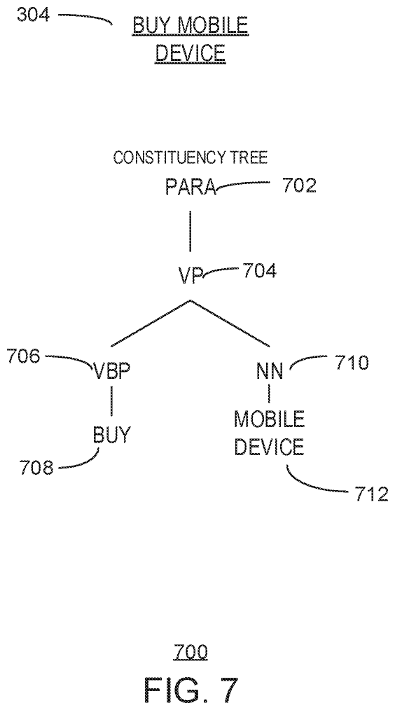

FIG. 2 is an example block diagram of a system for implementing a task generation engine. In some embodiments, the system 200 can include any suitable number of user signals such as search history 202 and browsing history log 204, among others. In some examples, the user signals are merged to form a search merged log 206. The search merged log 206 can be stored in an offline data repository for each user. The activity information extractor 208 can retrieve the search merged log 206 and identify or extract activity information. The activity information, as referred to herein, can indicate various tuples of data associated with a user. For example, the activity information can indicate a tuple including an activity, a time associated with the activity, and a score indicating a likelihood that the activity belongs to a task. In some embodiments, the activity can be a separate subtuple that includes a subintent, an action, and an entity. In some examples, the subintent can indicate an intent from a search query based on a classifier from any suitable web browser, among others. For example, the subintent can indicate that a search query is related to purchasing a product, among others. The classifiers can be trained for various topics or segments related to products, music, literature, pop culture, and the like. In some examples, the entities are extracted from search queries via web browser entity streams. The entities from the user signals or logged data can be identified using a web browser that stamps a dominant entity in each web page. For example, a web browser can store metadata indicating an entity related to each web page. In some examples, the device can extract an action using natural language processing to detect action keywords from a search query. For example, the device can identify part of speech (POS) tags from a search query using any suitable statistical parsing and linguistic analysis applications. In some examples, the device generates constituency trees based on the POS tags, which represent each word in a search query. The constituency trees are described in greater detail below in relation to FIGS. 6 and 7. In some examples, output from the activity information extractor 208 is stored in a user centric activity stream 210, which serves as a data repository for a user's search activity over a period of time.

In some embodiments, an activity clustering engine 212 can cluster identified activities into related activities that form a task using any suitable clustering technique. In some examples, the activity clustering engine 212 can cluster identified activities based on hierarchical agglomerative clustering (HAC) techniques using a Jaccard distance as distance function. The HAC technique of cluster analysis can generate a hierarchy of clusters in a bottom up approach, wherein activity observations start in a single cluster and pairs of clusters are merged as a device moves up the hierarchy. In some examples, the Jaccard distance or coefficient measures a similarity between finite sample sets and is defined as the size of an intersection between two sample sets divided by the size of union.

In some embodiments, the activity ordering engine 214 can generate an ordering of the clustered activities, which produces a time series of activities related to a task, based on any suitable ordering technique. The activity ordering engine 214 can order the activities within a cluster based on a time in which the activities were performed by users. The activity ordering engine 214 can output a set of ordered activity clusters or temporal activity clusters as tasks stored in a task data repository 216.

In some examples, the ordered activity clusters related to a task can be reviewed by an expert user via a manual judgment component 218. The expert user can evaluate the quality of the ordered activity clusters and filter out invalid activities unrelated to a task. In some embodiments, the system 200 can generate a list of the ordered activity clusters as refined tasks 220 and sort the list based on a frequency in which the tasks appear in an overall set from a plurality of users. In some examples, the list of ordered activity clusters or refined tasks 220 can be represented as a graph or set of connected components.

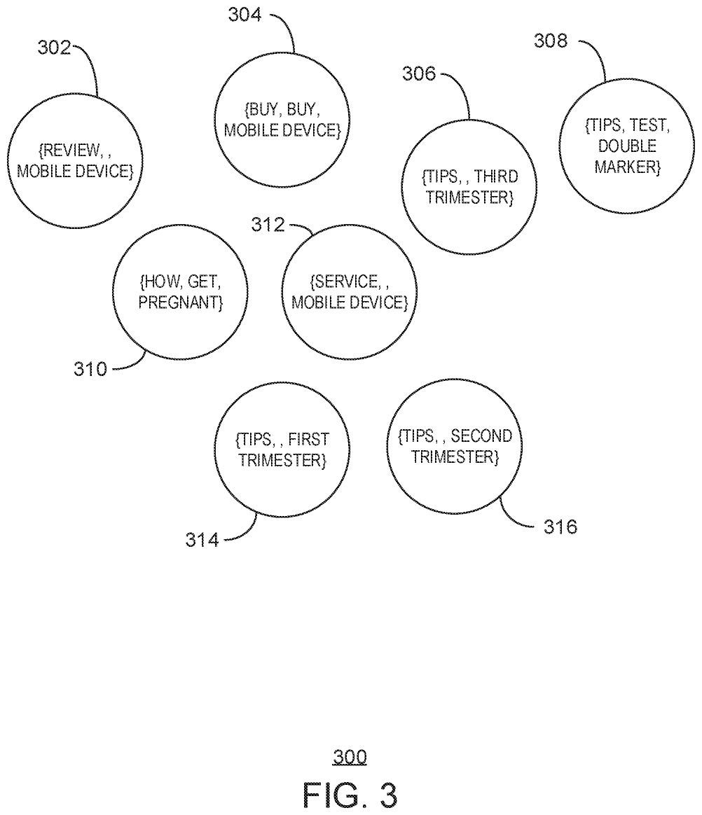

FIG. 3 is a block diagram of examples of unclustered and unordered activities. In some examples, each activity corresponds to a different search query. The search query can be detected by any suitable device such as a mobile device, desktop device, digital assistant, email server, and the like. In the example of FIG. 3, a device detects eight search queries: {review, mobile device} 302, {buy, buy, mobile device} 304, {tips, third trimester} 306, {tips, test, double marker} 308, {how, get, pregnant} 310, {service, mobile device} 312, {tips, first trimester} 314, and {tips, second trimester} 316. The user queries 302-318 of FIG. 3 are not identified as belonging to a shared task and a sequential order of the user queries 302-318 is not identified.

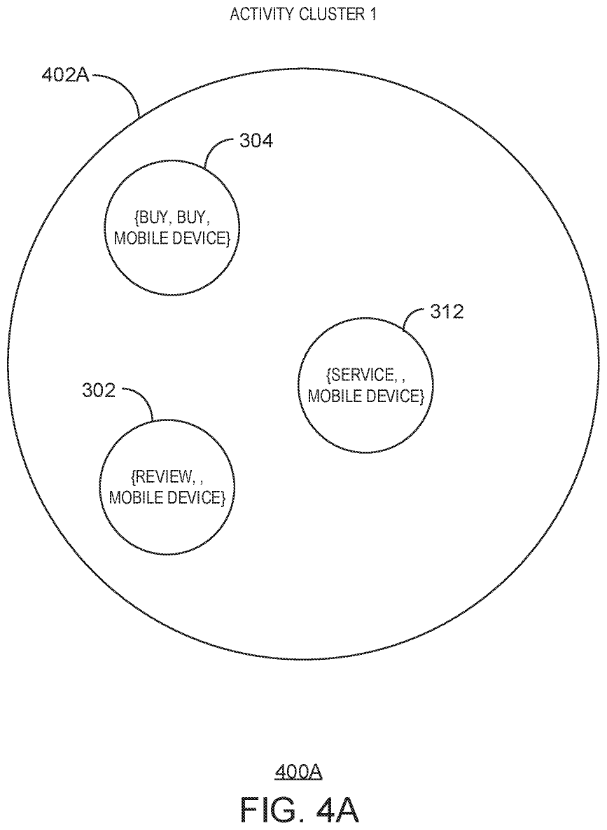

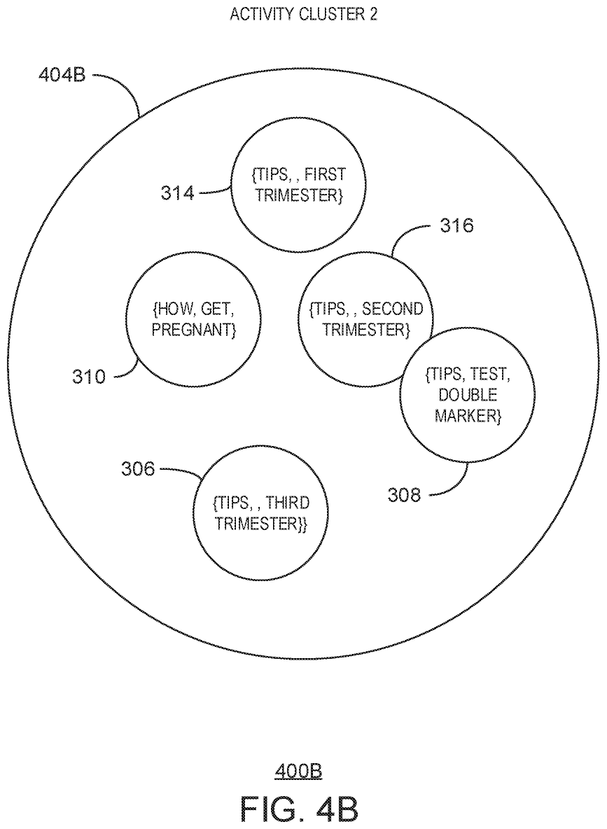

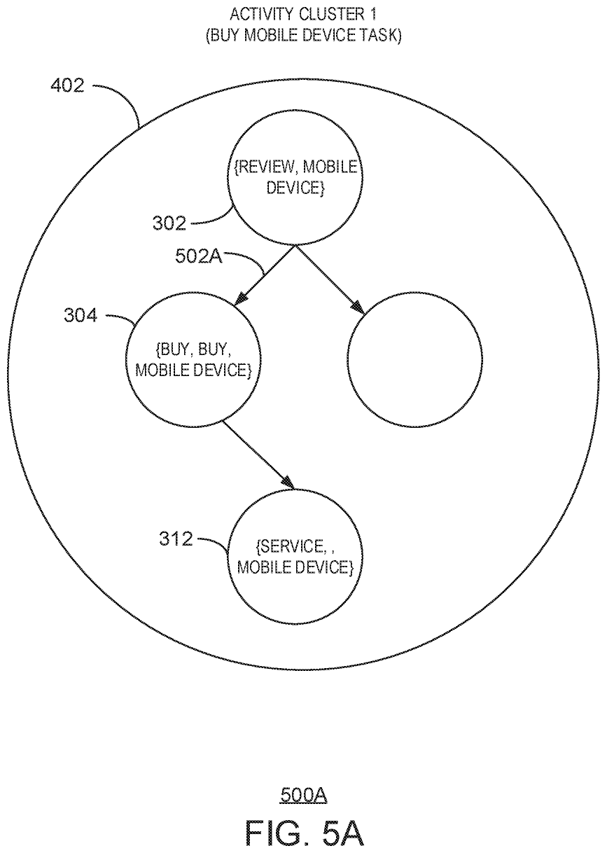

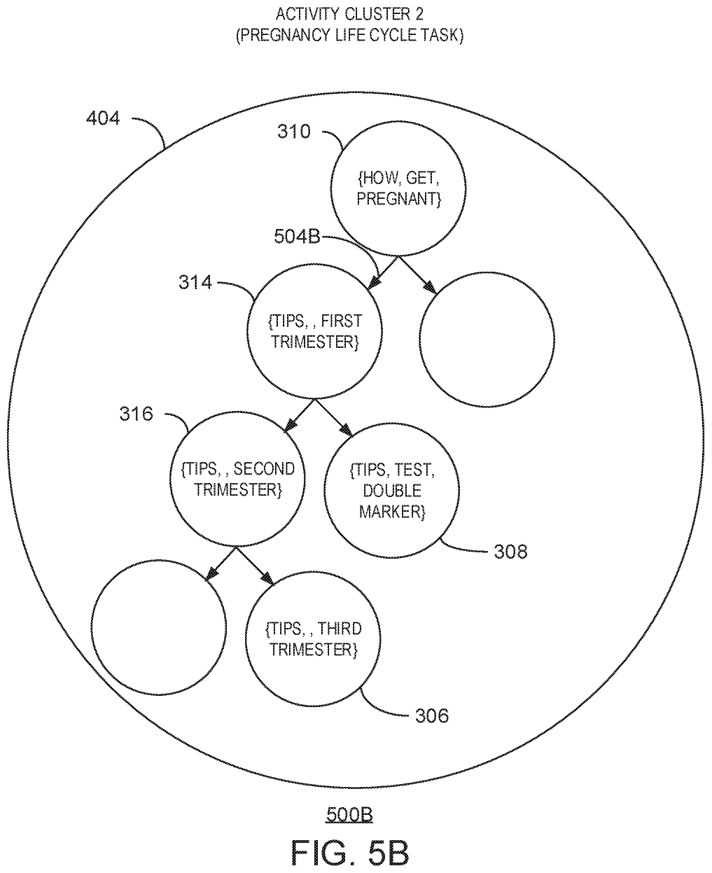

FIGS. 4A and 4B are block diagrams of examples of clustered and unordered activities. In some examples, a device can organize search queries into any suitable number of activity clusters. Each activity cluster can include any suitable number of search queries related to a shared task. For example, FIG. 4A indicates an activity cluster 1 402A. In activity cluster 1 402A, user search queries related to mobile devices are stored. For example, activity cluster 1 402A can include the user queries discussed above in relation to FIG. 3 related to mobile devices such as {review, mobile device} 302, {buy, buy, mobile device} 304, and {service, mobile device} 312. In some examples, activity cluster 2 404B of FIG. 4B can include user queries related to pregnancy issues. For example, activity cluster 2 404B can include user queries discussed above in relation to FIG. 3 such as {tips, third trimester} 306, {tips, test, double marker} 308, {how, get, pregnant} 310, {tips, first trimester} 314, and {tips, second trimester} 316. The ordering or temporal relationship between user queries or activities is discussed below in relation to FIGS. 5A and 5B.

FIGS. 5A and 5B are block diagrams of examples of clustered and ordered activities. In some embodiments, a device can detect an ordering of search queries. For example, the device can detect from a plurality of users that a series of search queries share a temporal relationship. In one example, the activity cluster 1 402A of FIG. 4A can be ordered such that the search query or activity {review, mobile device} 302 is identified as a first activity of a time series 502A of FIG. 5A related to the activity cluster 1 402A. In some examples, the search query {buy, buy, mobile device} 304 is identified as the second activity of the time series, and the search query {service, mobile device} 312 is identified as the third activity of the time series. Similarly, a device can generate a time series 504B of FIG. 5B related to the activity cluster 2 404B of FIG. 4B. Specifically, the device can generate the time series 504B, which indicates that the search queries follow the following order: {how, get, pregnant} 310, {tips, first trimester} 314, {tips, second trimester} 316, {tips, test, double marker} 308, and {tips, third trimester} 306. Accordingly, the device can detect if a user enters a search query related to how to get pregnant or a first trimester tip, and the system can predict subsequent user queries or activities as shown below in relation to FIG. 8.

FIG. 6 is an example of a constituency tree of a search query. The constituency tree 600 can be any suitable ordered, rooted data tree that represents a syntactic structure of a string or sentence. In some examples, the constituency tree 600 can be based on a context-free grammar. The constituency tree 600 can be generated based on constituency grammars or phrase structure grammars, or a dependency relation based on dependency grammars.

In some embodiments, the constituency tree 600 can include any suitable number of verbs and nouns, among others, from a search query or user query. The example constituency tree 600 corresponds to search query “how to get pregnant” related to the tuple {how, get, pregnant} 310 of FIG. 3. In some embodiments, a para root node 602 can indicate a node that is related to each of the terms or elements in a search query. The top node 604 can indicate a combination of various subordinate clauses. For example, the top node 604 can connect the sbar node 606 for subordinate clauses related to whadvp node 608 and “s” node 610. The whadvp node 608 can indicate an adverb and the “s” node 610 node can indicate a root clause, or a clause that is not embedded. In some examples, the whadvp node 608 is connected to a wrb node 612 that indicates an adverb “how” node 614. The wrb node 612 can also include adverbs such as when, whence, where, or why. The “s” node 610 can be connected to a verb phrase node or vp node 616 such as “to” nodes 618 and 620, and a second verb phrase such as the vp node 622. The second verb phrase or vp node 622 can be connected to verb or vb node 624 associated with the “get” node 626 and the adjective phrase node (ADJP) 628. The adjective phrase node (ADJP) 628 can connect the JJ node 630 to the “pregnant” node 632. In some embodiments, a device can use the constituency tree 600 to identify a subintent, action, entity, and activity. For example, the device can identify the subintent as “how,” the action as “get,” the entity as “pregnant,” and the activity as “{how, get, pregnant}.”

In some example, the constituency tree 600 can include fewer or additional nodes based on different user queries. For example, the constituency tree 600 can also include nodes related to coordinating conjunctions, cardinal numbers, determiners, prepositions, singular or plural nouns, pronouns, and the like.

FIG. 7 is another example of a constituency tree of a search query. The example constituency tree 700 is based on a search query for buying a mobile device related to tuple {Buy, Buy, Mobile Device} 304 of FIG. 3. In some examples, the constituency tree 700 can include a para root node 702 connected to a verb phrase or vp node 704 for a user query or search query. The verb phrase vp node 704 can connect to a verb, non-third person singular present (VBP) node 706 that indicates the “buy” node 708. The verb phrase node 704 can also connect to a singular noun (NN) node 710 that indicates the “mobile device” node 712. In some embodiments, a device can use the constituency tree 700 to identify a subintent, action, entity, and activity. For example, the device can identify the subintent as “buy,” the action as “buy,” the entity as the “mobile device,” and the activity as “{buy, buy, mobile device}.”

In some example, the constituency tree 700 can include fewer or additional nodes based on different user queries. For example, the constituency tree 700 can also include nodes related to coordinating conjunctions, cardinal numbers, determiners, prepositions, singular or plural nouns, pronouns, and the like.

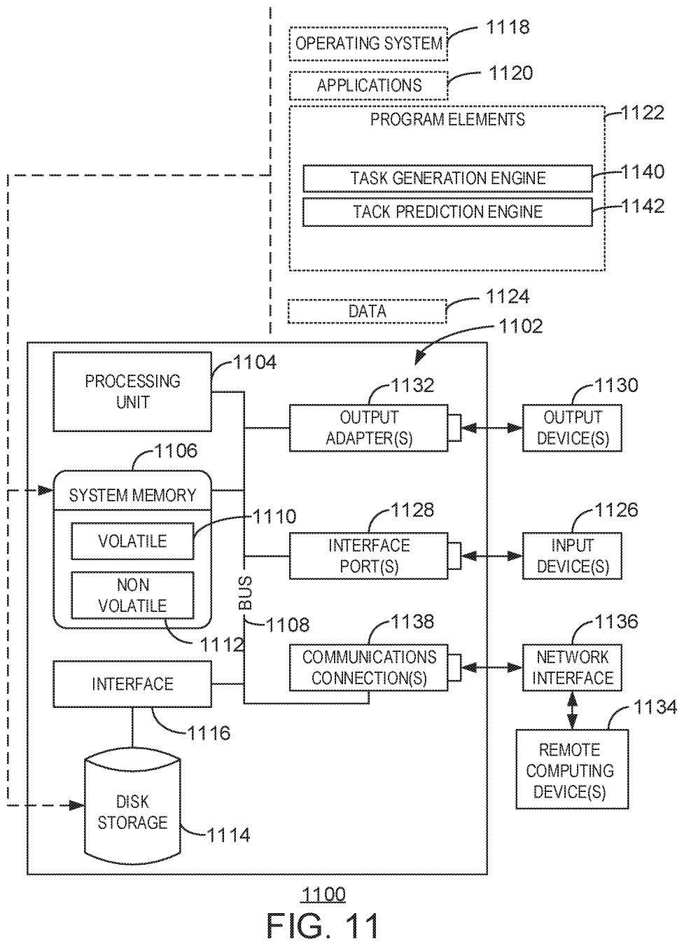

FIG. 8 is an example block diagram of a task prediction engine. In some embodiments, the task prediction engine 800 can be implemented with any suitable computing device such as the computing system 1102 of FIG. 11. The task prediction engine 800 can detect a task related to a search query and predict a subsequent activity or any future activity to be performed. The task prediction engine 800 can also predict a time at which the activity should be performed during the lifecycle of the task.

In some embodiments, the task prediction engine 800 can detect a search query or user query 802 from any suitable data repository, mobile device, remote device, and the like. In some examples, the task prediction engine 800 is executed in response to a user search detected by a search engine, digital assistant, or a web page. The task prediction engine 800 can execute an activity information extractor 804 that can process user signals or user search queries to identify an activity of the user as a tuple of data. The tuple can include information such as <Activity, Time, Score>, where Activity is a tuple of <SubIntent, Action, Entity>. The activity information extractor 804 can implement the same techniques as the activity information extractor 208 of FIG. 2.

In some embodiments, the task prediction engine 800 can include a task activity matching 806 component that can match an activity identified in a user query with activities in a task set 808. In some examples, the task set 808 is populated with previously identified tasks detected by the task generation engine 200 of FIG. 2. In some examples, matching an activity to a task in the task set 808 can include calculating a Jaccard coefficient function to find the similarity. The result of the task activity matching 806 component can be stored in an activity data repository 810 that stores tuples of data such as a vector tuple including an activity node, time, and score. The score can indicate a likelihood that an activity identified from a user query 802 is related to a task identified from the task set 808.

In some embodiments, the task correlation engine 812 can correlate the activity identified in the user query 802 with tasks in the task set 808. In some examples, the task correlation engine 812 can include any suitable matching technique or algorithm as described below. The task correlation engine 812 can also write a matching activity or node in a user data store or PDP 814 based on the user query 802.

In some examples, the task correlation engine 812 can calculate a final score for each of the predicted next activity nodes of an activity cluster. The final score can include any combination of a static score, a dynamic score, and a time difference score. In some embodiments, the static score can indicate a likelihood that a task or activity cluster is relevant to an activity detected from a user query. A dynamic score can detect a number of ancestor nodes previously traversed by a user. In some examples, the task correlation engine 812 can calculate the dynamic score based on determining a number of ancestors related to a task that have a flag set to used or accessed. In some examples, the time difference score can indicate a time gap between the occurrence of an activity detected in a user query and the activity next node predicted by the task prediction engine 800. The task correlation engine 812 can calculate the final score as a weighted average of the static score, dynamic score, and time difference score, or any other suitable combination of the scores. For example, the task correlation engine 812 can also calculate the final score as a non-weighted average of the static score, dynamic score, and the time difference score, among others.

In some embodiments, if the final score is less than a predetermined threshold value, the task prediction engine 800 can mark an activity node flag of a predicted subsequent activity as not applicable. The activity node flag of the predicted subsequent activity can indicate to the task prediction engine 800 to ignore the next predicted subsequent activity for future activity predictions. In some embodiments, if the final score exceeds a predetermined threshold value, the task prediction engine can mark the next predicted activity node as used and update the data repository or PDP 814. The task prediction engine 800 can also remove the parent node of the next predicted activity node from the data repository or PDP 814. The next predicted activity can be used by search engines, web pages, and the like, in future user search queries.

In some embodiments, the task prediction engine 800 can store tasks identified by the task correlation 812 in the user data store (PDP) 814. Any number of devices and services, such as personal digital assistants, mobile devices, search engines, and the like, can access the information stored in the PDP 814 to determine a predicted subsequent activity based on previous user queries. In some examples, a suggestion engine or task prediction engine 800 can be executed as a background task for each user. The task prediction engine 800 can detect and read user activities from the data repository or PDP 814 related to each user. The task prediction engine 800 can also detect or read curated tasks from refined tasks or a feeds index. In some embodiments, the task prediction engine 800 can, for each matching node from the PDP 814, find a next set of nodes or activities to be executed. The task prediction engine 800 can also filter nodes marked as used and not applicable.

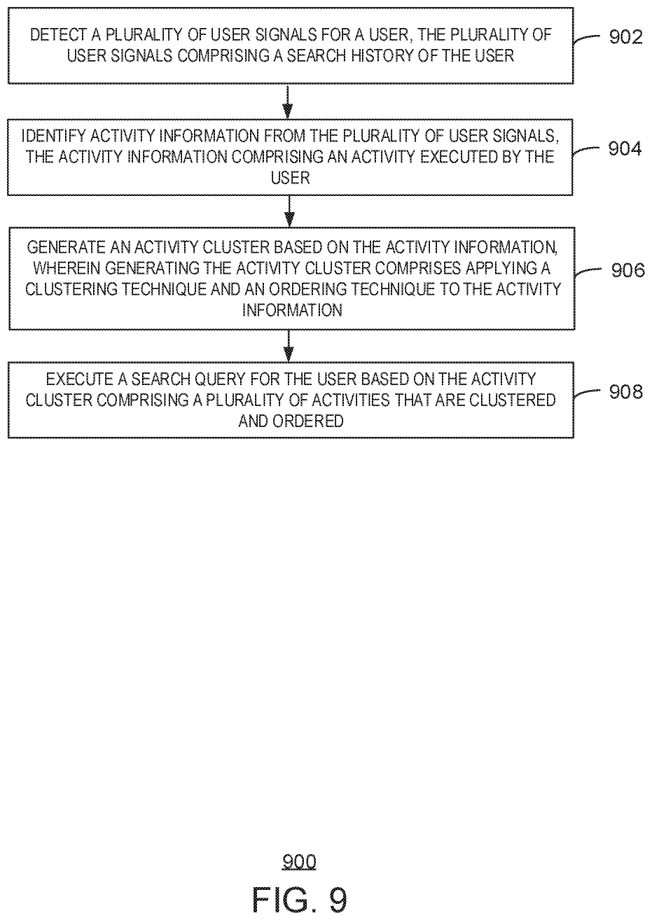

FIG. 9 is a process flow diagram of an example method for generating tasks. The method 900 can be implemented with any suitable computing device, such as the computing system 1102 of FIG. 11.

At block 902, a processor can detect a plurality of user signals for a user, the plurality of user signals comprising a search history of the user. In some embodiments, the plurality of user signals can also include a browsing history of the user, a conversation history of the user, a digital assistant history of the user, and an email history of the user, among others. The user signals can be collected from any number of applications executed locally on a computing device or remotely by an external server. In some examples, the user signals correspond to logged data for a user, which can be stored in any suitable data repository such as a database, among others. In some embodiments, the user signals are stored on a local storage device or a remote storage device.

At block 904, the processor can identify activity information from the plurality of user signals. In some examples, the activity information can include an activity executed by the user. In some examples, the activity includes a subintent, an action, and an entity. The processor can identify the subintent, the action, and the entity from a constituency tree generated from the user query as discussed above in relation to FIGS. 2, 6, and 7. In some embodiments, the activity information further comprises a time associated with the activity executed by the user and a score indicating a likelihood that the activity is related to a task or activity cluster.

At block 906, the processor can generate an activity cluster based on the activity information, wherein generating the activity cluster comprises applying a clustering technique and an ordering technique to the activity information. In some embodiments, the activity cluster is a time series based on user tasks performed in a sequential order. The clustering technique is discussed above in relation to FIG. 4. The ordering technique is discussed above in relation to FIG. 5.

At block 908, the processor can execute a search query for the user based on the activity cluster comprising a plurality of activities that are clustered and ordered. In some embodiments, the search query can return any suitable information for an activity identified from the search query. In some examples, the processor can return predicted activities to be executed, wherein the predicted activities are identified based on techniques described in greater detail below in relation to FIG. 10. For example, the processor can identify an activity node corresponding to the search query, detect that the activity node belongs to an activity cluster, and determine a subsequent activity or user query based on the activity cluster.

In one embodiment, the process flow diagram of FIG. 9 is intended to indicate that the steps of the method 900 are to be executed in a particular order. Alternatively, in other embodiments, the steps of the method 900 can be executed in any suitable order and any suitable number of the steps of the method 900 can be included. Further, any number of additional steps may be included within the method 900, depending on the specific application.

FIG. 10 is a process flow diagram of an example method for predicting tasks. The method 1000 can be used to manufacture a computing device, such as the computing system 1102 of FIG. 11.

At block 1002, a processor can match an activity from a search query to a previously identified task. In some examples, the processor can calculate a Jaccard coefficient to match the activity from the search query to the previously identified task. The Jaccard coefficient can measure a similarity between finite sample sets and is defined as the size of an intersection between two sample sets divided by the size of union. The sample sets can correspond to a set of user queries from a user or set of users. In some examples, the Jaccard coefficient measures a similarity between an activity included in a user search query and a set of previously executed user search queries. In some embodiments, the set of previously executed user search queries are organized into activity clusters and the Jaccard coefficient identifies an activity cluster related to a task that is similar to the search query.

At block 1004, the processor can generate a final score indicating the activity is related to the task, the final score comprising a combination of a static score, a dynamic score, and a time difference score. In some examples, the processor can calculate a weighted average of the static score, dynamic score, and the time difference score to generating the final score. In some embodiments, the static score indicates a likelihood that the task is related to the activity, the dynamic score indicates a number of ancestors of the activity cluster traversed by the user, and the time different score indicates a time gap between activity nodes of the activity cluster.

At block 1006, the processor can predict a subsequent activity to execute based on the final score. In some embodiments, the subsequent activity corresponds to a next node in an activity cluster related to the task. For example, the activity cluster related to the task can include any number of nodes indicating a series of activities executed in sequential order. The processor can determine a node from the activity cluster that matches an activity from a user search query and predict the next user search query or activity based on the activity cluster. In some examples, the processor can also determine a time gap between the current user search query and the subsequent activity from the activity cluster. For example, the processor can determine that a time gap of approximately three months can separate a current user search for pregnancy trimester tips from a subsequent user search for the next pregnancy trimester's tips. In some examples, the time gap between nodes of the activity cluster can be linear or non-linear. For example, the time gap between nodes of an activity cluster can vary and may not be the same for all nodes. In some embodiments, the processor can automatically execute a predicted subsequent activity in response to detecting a time gap between activity nodes has been exceeded. For example, the processor can automatically, without user input, perform and return predicted search query results related to a subsequent search query, provide tips, provide reminders, execute tasks via a digital personal assistant, and the like. In some embodiments, the activity cluster can indicate a series of consecutive activities to be executed such as recording media from any suitable source at particular times, and the like.

In one example, the activity cluster can be related to a television show or program. For example, the activity cluster can involve sequential activities including finding the schedule of the user's favorite television shows, reminding the user of the favorite television shows, and generating a reminder that the user record the television shows on that particular time. In another example, an activity cluster can be related to watching a movie. For example, the activity cluster can include activities such as detecting the movies (old or new) based on a user's choice of genre, detecting the show time for a new movie in a nearby theater, and/or determining the on air time for a movie to be broadcast, and reminding the time to the user and suggesting to record the movie. In yet another example, an activity cluster can be related to suggesting a restaurant. For example, the activity cluster can include activities such as finding a nearby restaurant depending on a user's location, determining the usual time of user's lunch or dinner, providing a recommendation to the user for new restaurants based on reviews, and reminding the user to book a restaurant.

In one embodiment, the process flow diagram of FIG. 10 is intended to indicate that the steps of the method 1000 are to be executed in a particular order. Alternatively, in other embodiments, the steps of the method 1000 can be executed in any suitable order and any suitable number of the steps of the method 1000 can be included. Further, any number of additional steps may be included within the method 1000, depending on the specific application.

Some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 11 discussed below, provides details regarding different systems that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like.

FIG. 11 is a block diagram of an example of a computing system that can generate tasks and predict tasks to be executed. The example system 1100 includes a computing device 1102. The computing device 1102 includes a processing unit 1104, a system memory 1106, and a system bus 1108. In some examples, the computing device 1102 can be a gaming console, a personal computer (PC), an accessory console, a gaming controller, a laptop, or a mobile device, among other computing devices. In some examples, the computing device 1102 can be a node in a cloud network.

The system bus 1108 couples system components including, but not limited to, the system memory 1106 to the processing unit 1104. The processing unit 1104 can be any of various available processors. Dual microprocessors and other multiprocessor architectures also can be employed as the processing unit 1104.

The system bus 1108 can be any of several types of bus structure, including the memory bus or memory controller, a peripheral bus or external bus, and a local bus using any variety of available bus architectures known to those of ordinary skill in the art. The system memory 1106 includes computer-readable storage media that includes volatile memory 1110 and nonvolatile memory 1112.

The basic input/output system (BIOS), containing the basic routines to transfer information between elements within the computer 1102, such as during start-up, is stored in nonvolatile memory 1112. By way of illustration, and not limitation, nonvolatile memory 1112 can include read-only memory (ROM), programmable ROM (PROM), electrically programmable ROM (EPROM), electrically erasable programmable ROM (EEPROM), or flash memory.

Volatile memory 1110 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 1102 also includes other computer-readable media, such as removable/non-removable, volatile/non-volatile computer storage media. FIG. 11 shows, for example a disk storage 1114. Disk storage 1114 includes, but is not limited to, devices like a magnetic disk drive, floppy disk drive, tape drive, Jaz drive, Zip drive, LS-210 drive, flash memory, memory sticks, punch cards, or paper tape. The disk storage may be a flash memory used for operating system storage, game storage, media storage, etc.

In addition, disk storage 1114 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1114 to the system bus 1108, a removable or non-removable interface is typically used such as interface 1116.

It is to be appreciated that FIG. 11 describes software that acts as an intermediary between users and the basic computer resources described in the suitable operating environment 1100. Such software includes an operating system 1118. Operating system 1118, which can be stored on disk storage 1114, acts to control and allocate resources of the computer 1102.

System applications 1120 take advantage of the management of resources by operating system 1118 through program elements 1122 and program data 1124 stored either in system memory 1106 or on disk storage 1114. It is to be appreciated that the disclosed subject matter can be implemented with various operating systems or combinations of operating systems.

A user enters commands or information into the computer 1102 through input devices 1126. Input devices 1126 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. In some examples, an input device can include Natural User Interface (NUI) devices. NUI refers to any interface technology that enables a user to interact with a device in a “natural” manner, free from artificial constraints imposed by input devices such as mice, keyboards, remote controls, and the like. In some examples, NUI devices include devices relying on speech recognition, touch and stylus recognition, gesture recognition both on screen and adjacent to the screen, air gestures, head and eye tracking, voice and speech, vision, touch, gestures, and machine intelligence. For example, NUI devices can include touch sensitive displays, voice and speech recognition, intention and goal understanding, and motion gesture detection using depth cameras such as stereoscopic camera systems, infrared camera systems, RGB camera systems and combinations of these. NUI devices can also include motion gesture detection using accelerometers or gyroscopes, facial recognition, three-dimensional (3D) displays, head, eye, and gaze tracking, immersive augmented reality and virtual reality systems, all of which provide a more natural interface. NUI devices can also include technologies for sensing brain activity using electric field sensing electrodes. For example, a NUI device may use Electroencephalography (EEG) and related methods to detect electrical activity of the brain. The input devices 1126 connect to the processing unit 1104 through the system bus 1108 via interface ports 1128. Interface ports 1128 include, for example, a serial port, a parallel port, a game port, and a universal serial bus (USB).

Output devices 1130 use some of the same type of ports as input devices 1126. Thus, for example, a USB port may be used to provide input to the computer 1102 and to output information from computer 1102 to an output device 1130.

Output adapter 1132 is provided to illustrate that there are some output devices 1130 like monitors, speakers, and printers, among other output devices 1130, which are accessible via adapters. The output adapters 1132 include, by way of illustration and not limitation, video and sound cards that provide a means of connection between the output device 1130 and the system bus 1108. It can be noted that other devices and systems of devices provide both input and output capabilities such as remote computing devices 1134.

The computer 1102 can be a server hosting various software applications in a networked environment using logical connections to one or more remote computers, such as remote computing devices 1134. The remote computing devices 1134 may be client systems configured with web browsers, PC applications, mobile phone applications, and the like. The remote computing devices 1134 can be a personal computer, a server, a router, a network PC, a workstation, a microprocessor based appliance, a mobile phone, a peer device or other common network node and the like, and typically includes many or all of the elements described relative to the computer 1102.

Remote computing devices 1134 can be logically connected to the computer 1102 through a network interface 1136 and then connected via a communication connection 1138, which may be wireless. Network interface 1136 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 1138 refers to the hardware/software employed to connect the network interface 1136 to the bus 1108. While communication connection 1138 is shown for illustrative clarity inside computer 1102, it can also be external to the computer 1102. The hardware/software for connection to the network interface 1136 may include, for exemplary purposes, internal and external technologies such as, mobile phone switches, modems including regular telephone grade modems, cable modems and DSL modems, ISDN adapters, and Ethernet cards.

The computer 1102 includes one or more program elements 1122, such as a task generation engine 1140, and a task prediction engine 1142. In some embodiments, the task generation engine 1140 can detect a plurality of user signals for a user, the plurality of user signals comprising a search history of the user. The task generation engine 1140 can also identify activity information from the plurality of user signals, wherein the activity information includes an activity executed by the user. The task generation engine 1140 can also generate an activity cluster based on the activity information, wherein generating the activity cluster comprises applying a clustering technique and an ordering technique to the activity information. Furthermore, the task generation engine 1140 can execute a search query for the user based on the activity cluster comprising a plurality of activities that are clustered and ordered.

In some embodiments, the task prediction engine 1142 can match an activity from a search query to a task. The task prediction engine 1142 can also generate a final score indicating the activity is related to the task. In some examples, the final score includes a combination of a static score, a dynamic score, and a time difference score. Furthermore, the task prediction engine 1142 can predict a subsequent activity to be executed based on the final score.

It is to be understood that the block diagram of FIG. 11 is not intended to indicate that the computing system 1102 is to include all of the components shown in FIG. 11. Rather, the computing system 1102 can include fewer or additional components not illustrated in FIG. 11 (e.g., additional applications, additional program elements, additional memory devices, additional network interfaces, etc.). Furthermore, any of the functionalities of the task generation engine 1140, and task prediction engine 1142, may be partially, or entirely, implemented in hardware and/or in the processor 1104. For example, the functionality may be implemented with an application specific integrated circuit, in logic implemented in the processor 1104, or in any other device.

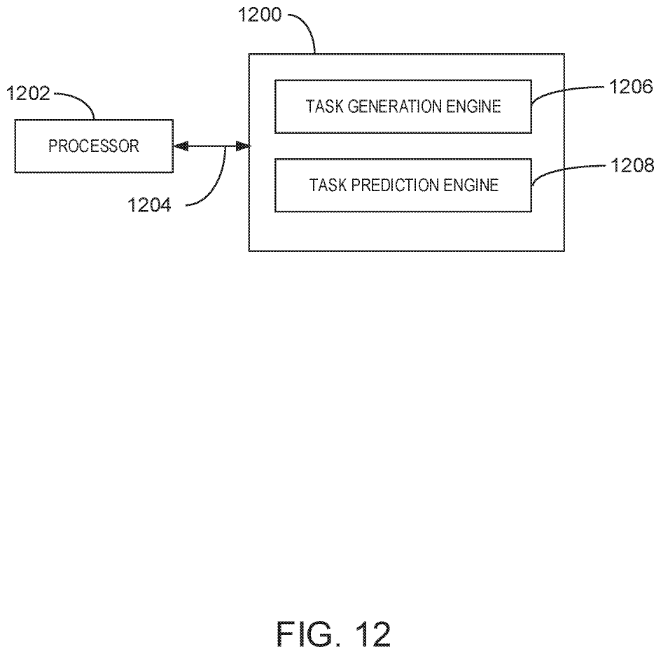

FIG. 12 is a block diagram of an example computer-readable storage media that can execute tasks and predict tasks. The tangible, computer-readable storage media 1210 may be accessed by a processor 1202 over a computer bus 1204. Furthermore, the tangible, computer-readable storage media 1200 may include code to direct the processor 1202 to perform the steps of the current methods.

The various software components discussed herein may be stored on the tangible, computer-readable storage media 1200, as indicated in FIG. 12. For example, the tangible computer-readable storage media 1200 can include a task generation engine 1206 and task prediction engine 1208. In some embodiments, the task generation engine 1206 can detect a plurality of user signals for a user, the plurality of user signals comprising a search history of the user. The task generation engine 1206 can also identify activity information from the plurality of user signals, the activity information comprising an activity executed by the user. The task generation engine 1206 can also generate an activity cluster based on the activity information, wherein generating the activity cluster comprises applying a clustering technique and an ordering technique to the activity information. Furthermore, the task generation engine 1206 can execute a search query for the user based on the activity cluster comprising a plurality of activities that are clustered and ordered.

In some embodiments, the task prediction engine 1208 can match an activity from a search query to a task. The task prediction engine 1208 can also generate a final score indicating the activity is related to the task, the final score comprising a combination of a static score, a dynamic score, and a time difference score. Furthermore, the task prediction engine 1208 can predict a subsequent activity to be executed based on the final score.

It is to be understood that any number of additional software components not shown in FIG. 12 may be included within the tangible, computer-readable storage media 1200, depending on the specific application.

### EXAMPLE 1

In one embodiment, a system for executing tasks can include a processor to execute code to detect a plurality of user signals for a user, the plurality of user signals comprising a search history of the user. The processor can also identify activity information from the plurality of user signals, the activity information comprising an action executed by the user. Furthermore, the processor can generate an activity cluster based on the activity information, wherein generating the activity cluster comprises applying a clustering technique and an ordering technique to the activity information. In addition, the processor can execute a search query for the user based on the activity cluster comprising a plurality of activities that are clustered and ordered.

Alternatively, or in addition, the processor can match an activity from the search query to a task, the task comprising the activity cluster, generate a final score indicating the activity is related to the task, the final score comprising a combination of a static score, a dynamic score, and a time difference score, and predict a subsequent activity to be executed based on the final score. Alternatively, or in addition, the processor can calculate a weighted average of the static score, the dynamic score, and the time difference score to generate the final score. Alternatively, or in addition, the static score indicates a likelihood that the task is related to the activity, the dynamic score indicates a number of ancestors of the activity cluster traversed by the user, and the time difference score indicates a time gap between activity nodes of the activity cluster. Alternatively, or in addition, the processor can calculate a Jaccard coefficient to match the activity from the search query to the task. Alternatively, or in addition, the plurality of user signals further comprise a browsing history of the user, a conversation history of the user, a digital assistant history of the user, and an email history of the user. Alternatively, or in addition, the activity information further comprises a time associated with the activity executed by the user. Alternatively, or in addition, the activity comprises a subintent, the action, and an entity, and wherein the processor can identify the subintent, the action, and the entity from a constituency tree generated from the search query. Alternatively, or in addition, the activity cluster is a time series based on user activities performed in a sequential order, and wherein the subsequent activity comprises providing a tip related to the search query, providing a reminder related to the search query, or returning a search query result related to a subsequent search query.

### EXAMPLE 2

Another embodiment described herein includes a method for executing tasks that includes detecting a plurality of user signals for a user, the plurality of user signals comprising a search history of the user. Additionally, the method can include identifying activity information from the plurality of user signals, the activity information comprising an action executed by the user. Furthermore, the method can include generating an activity cluster based on the activity information, wherein generating the activity cluster comprises applying a clustering technique and an ordering technique to the activity information. Moreover, the method can include executing a search query for the user based on the activity cluster comprising a plurality of activities that are clustered and ordered.

Alternatively, or in addition, the method can include matching an activity from the search query to a task, the task comprising the activity cluster, generating a final score indicating the activity is related to the task, the final score comprising a combination of a static score, a dynamic score, and a time difference score, and predicting a subsequent activity to be executed based on the final score. Alternatively, or in addition, the method can include calculating a weighted average of the static score, the dynamic score, and the time difference score to generate the final score. Alternatively, or in addition, the static score indicates a likelihood that the task is related to the activity, the dynamic score indicates a number of ancestors of the activity cluster traversed by the user, and the time difference score indicates a time gap between activity nodes of the activity cluster. Alternatively, or in addition, the method can include calculating a Jaccard coefficient to match the activity from the search query to the task. Alternatively, or in addition, the plurality of user signals further comprise a browsing history of the user, a conversation history of the user, a digital assistant history of the user, and an email history of the user. Alternatively, or in addition, the activity information further comprises a time associated with the activity executed by the user. Alternatively, or in addition, the activity comprises a subintent, the action, and an entity, and wherein the method includes identifying the subintent, the action, and the entity from a constituency tree generated from the search query. Alternatively, or in addition, the activity cluster is a time series based on user activities performed in a sequential order, and wherein the subsequent activity comprises providing a tip related to the search query, providing a reminder related to the search query, or returning a search query result related to a subsequent search query.

### EXAMPLE 3

Yet another embodiment described herein includes one or more computer readable storage media for executing tasks that can include a plurality of instructions, that in response to execution by a processor, cause the processor to detect a plurality of user signals for a user, the plurality of user signals comprising a search history of the user. The plurality of instructions can also cause the processor to identify activity information from the plurality of user signals, the activity information comprising an action executed by the user and generate an activity cluster based on the activity information, wherein generating the activity cluster comprises applying a clustering technique and an ordering technique to the activity information. Furthermore, the plurality of instructions can also cause the processor to match an activity from a search query to a task, the task comprising the activity cluster and generate a final score indicating the activity is related to the task, the final score comprising a combination of a static score, a dynamic score, and a time difference score. Moreover, the plurality of instructions can also cause the processor to predict a subsequent activity to be executed based on the final score, wherein the subsequent activity is identified from the activity cluster, and execute the subsequent activity for the user at a predetermined time.

Alternatively, or in addition, the processor can calculate a weighted average of the static score, the dynamic score, and the time difference score to generate the final score. Alternatively, or in addition, the static score indicates a likelihood that the task is related to the activity, the dynamic score indicates a number of ancestors of the activity cluster traversed by the user, and the time difference score indicates a time gap between activity nodes of the activity cluster. Alternatively, or in addition, the processor can calculate a Jaccard coefficient to match the activity from the search query to the task. Alternatively, or in addition, the plurality of user signals further comprise a browsing history of the user, a conversation history of the user, a digital assistant history of the user, and an email history of the user. Alternatively, or in addition, the activity information further comprises a time associated with the activity executed by the user. Alternatively, or in addition, the activity comprises a subintent, the action, and an entity, and wherein the processor identifies the subintent, the action, and the entity from a constituency tree generated from the search query. Alternatively, or in addition, the activity cluster is a time series based on user activities performed in a sequential order, and wherein the subsequent activity comprises providing a tip related to the search query, providing a reminder related to the search query, or returning a search query result related to a subsequent search query. Alternatively, or in addition, the subsequent activity comprises providing a tip related to the search query, providing a reminder related to the search query, or returning a search query result related to a subsequent search query.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for executing tasks, comprising:
a processor to execute code to:
detect a plurality of user signals for a user, the plurality of user signals comprising a search history of the user;
identify activity information from the plurality of user signals, the activity information comprising an action executed by the user;
generate an activity cluster based on the activity information, wherein generating the activity cluster comprises applying a clustering technique and an ordering technique to the activity information; and
execute a search query for the user based on the activity cluster comprising a plurality of activities that are clustered and ordered.

2. The system of claim 1, wherein the processor is to:
match an activity from the search query to a task, the task comprising the activity cluster;
generate a final score indicating the activity is related to the task, the final score comprising a combination of a static score, a dynamic score, and a time difference score; and
predict a subsequent activity to be executed based on the final score.

3. The system of claim 2, wherein the processor is to calculate a weighted average of the static score, the dynamic score, and the time difference score to generate the final score.

4. The system of claim 2, wherein the static score indicates a likelihood that the task is related to the activity, the dynamic score indicates a number of ancestors of the activity cluster traversed by the user, and the time difference score indicates a time gap between activity nodes of the activity cluster.

5. The system of claim 2, wherein the processor is to calculate a Jaccard coefficient to match the activity from the search query to the task.

6. The system of claim 1, wherein the plurality of user signals further comprise a browsing history of the user, a conversation history of the user, a digital assistant history of the user, and an email history of the user.

7. The system of claim 1, wherein the activity information further comprises a time associated with the activity executed by the user.

8. The system of claim 1, wherein the activity comprises a subintent, the action, and an entity, and wherein the processor identifies the subintent, the action, and the entity from a constituency tree generated from the search query.

9. The system of claim 2, wherein the activity cluster is a time series based on user activities performed in a sequential order, and wherein the subsequent activity comprises providing a tip related to the search query, providing a reminder related to the search query, or returning a search query result related to a subsequent search query.

10. A method for executing tasks, comprising:
detecting a plurality of user signals for a user, the plurality of user signals comprising a search history of the user;
identifying activity information from the plurality of user signals, the activity information comprising an action executed by the user;
generating an activity cluster based on the activity information, wherein generating the activity cluster comprises applying a clustering technique and an ordering technique to the activity information; and
executing a search query for the user based on the activity cluster comprising a plurality of activities that are clustered and ordered.

11. The method of claim 10, comprising:
matching an activity from the search query to a task, the task comprising the activity cluster;
generating a final score indicating the activity is related to the task, the final score comprising a combination of a static score, a dynamic score, and a time difference score; and
predicting a subsequent activity to be executed based on the final score.

12. The method of claim 11, comprising calculating a weighted average of the static score, the dynamic score, and the time difference score to generating the final score.

13. The method of claim 11, wherein the static score indicates a likelihood that the task is related to the activity, the dynamic score indicates a number of ancestors of the activity cluster traversed by the user, and the time difference score indicates a time gap between activity nodes of the activity cluster.

14. The method of claim 11, comprising calculating a Jaccard coefficient to match the activity from the search query to the task.

15. The method of claim 10, wherein the plurality of user signals further comprise a browsing history of the user, a conversation history of the user, a digital assistant history of the user, and an email history of the user.

16. The method of claim 10, wherein the activity information further comprises a time associated with the activity executed by the user.

17. The method of claim 10, wherein the activity comprises a subintent, the action, and an entity, and wherein the method further comprises identifying the subintent, the action, and the entity from a constituency tree generated from the search query.

18. The method of claim 11, wherein the activity cluster is a time series based on user activities performed in a sequential order, and wherein the subsequent activity comprises providing a tip related to the search query, providing a reminder related to the search query, or returning a search query result related to a subsequent search query.

19. One or more computer-readable storage media for executing tasks comprising a plurality of instructions that, in response to execution by a processor, cause the processor to:
detect a plurality of user signals for a user, the plurality of user signals comprising a search history of the user;
identify activity information from the plurality of user signals, the activity information comprising an action executed by the user;
generate an activity cluster based on the activity information, wherein generating the activity cluster comprises applying a clustering technique and an ordering technique to the activity information;
match an activity from a search query to a task, the task comprising the activity cluster;
generate a final score indicating the activity is related to the task, the final score comprising a combination of a static score, a dynamic score, and a time difference score;
predict a subsequent activity to be executed based on the final score, wherein the subsequent activity is identified from the activity cluster; and
execute the subsequent activity for the user at a predetermined time.

20. The one or more computer-readable storage media of claim 19, wherein the subsequent activity comprises providing a tip related to the search query, providing a reminder related to the search query, or returning a search query result related to a subsequent search query.
